(19) United States
(12) Patent Application Publication
(10) Pub. No.: US 2019/0094800 A1
(43) Pub. Date: Mar. 28, 2019

(54) IMAGE FORMING APPARATUS AND IMAGE FORMATION METHOD

(71) Applicants: KABUSHIKI KAISHA TOSHIBA, Tokyo (JP); TOSHIBA TEC KABUSHIKI KAISHA, Tokyo (JP)

(72) Inventors: Satoshi Itaya, Mishima Shizuoka (JP); Mitsutoshi Watanabe, Kannami Tagata Shizuoka (JP)

(21) Appl. No.: 15/712,574

(22) Filed: Sep. 22, 2017

(51) Int. Cl. G03G 15/08; G03G 9/08

(52) U.S. Cl. CPC G03G 21/203; G03G 15/0824; G03G 15/0849; G03G 9/08

(57) ABSTRACT

In accordance with an embodiment, an image forming apparatus comprises a humidity sensor, a developing device, a supply device, an acquisition section, and a controller. The supply device supplies the developing device with the developer based on toner density sensor detecting the toner density and a detection result of the toner density sensor among the developer in the developing device. Based on the detection result of the humidity sensor and a time from the completion of a processing relating to image formation to the start of a processing relating to next image formation, the acquisition section acquires a charge level of the developer in the developing device. Based on a first charge level acquired by the acquisition section at a first time and a second charge level acquired by the acquisition section at a second time after the first time, the controller controls to discharge the toner.

### FIELD

Embodiments described herein relate generally to an image forming apparatus and an image formation method.

### BACKGROUND

Conventionally, there is known an image forming apparatus which has a discharge port for discharging developer exhausted in a developing device and a carrier in a toner cartridge and supplies a carrier together with toner supply. In the image forming apparatus, there is a technology to maintain a quality of the developer by discharging exhausted developer and supplying the developer.

However, in the conventional technology, due to a large change in use environment and standing time, a charge amount of the developer in the developing device is lowered, and there is a possibility that the developer cannot be supplied sufficiently and image defect occurs.

### BRIEF DESCRIPTION OF THE DRAWINGS

FIG. 1 is an external view exemplifying the overall constitution of an image forming apparatus according to an embodiment;

FIG. 2 is a schematic view of a cross section of an image forming section centered on a developing section of the image forming apparatus according to the present embodiment;

FIG. 3 is a diagram illustrating the relationship between an amount of the developer and a charge amount of the developer;

FIG. 4 is a functional constitution diagram illustrating an example of the constitution of a control device included in the image forming apparatus according to the present embodiment;

FIG. 5 is a table illustrating an example of charge amount information according to the present embodiment;

FIG. 6 is a table illustrating an example of charge level information according to the present embodiment;

FIG. 7 is a table illustrating an example of previous and latter level information according to the present embodiment; and

FIG. 8 is a flowchart illustrating an example of the operation of the image forming apparatus according to the present embodiment.

### DETAILED DESCRIPTION

In accordance with an embodiment, an image forming apparatus comprises a humidity sensor, a developing device, a supply device, an acquisition section, and a controller. The humidity sensor detects surrounding humidity. The developing device houses developer containing a toner. The supply device supplies the developing device with the developer based on toner density sensor detecting the toner density and a detection result of the toner density sensor in the developer in the developing device. Based on the detection result of the humidity sensor and a time from the completion of a processing relating to image formation to the start of a processing relating to next image formation, the acquisition section acquires a charge level of the developer in the developing device. Based on a first charge level acquired by the acquisition section at a first time and a second charge level acquired by the acquisition section at a second time after the first time, the controller controls a discharge operation of enabling the developing device to discharge the toner.

Hereinafter, an image forming apparatus of an embodiment is described with reference to the accompanying drawings.

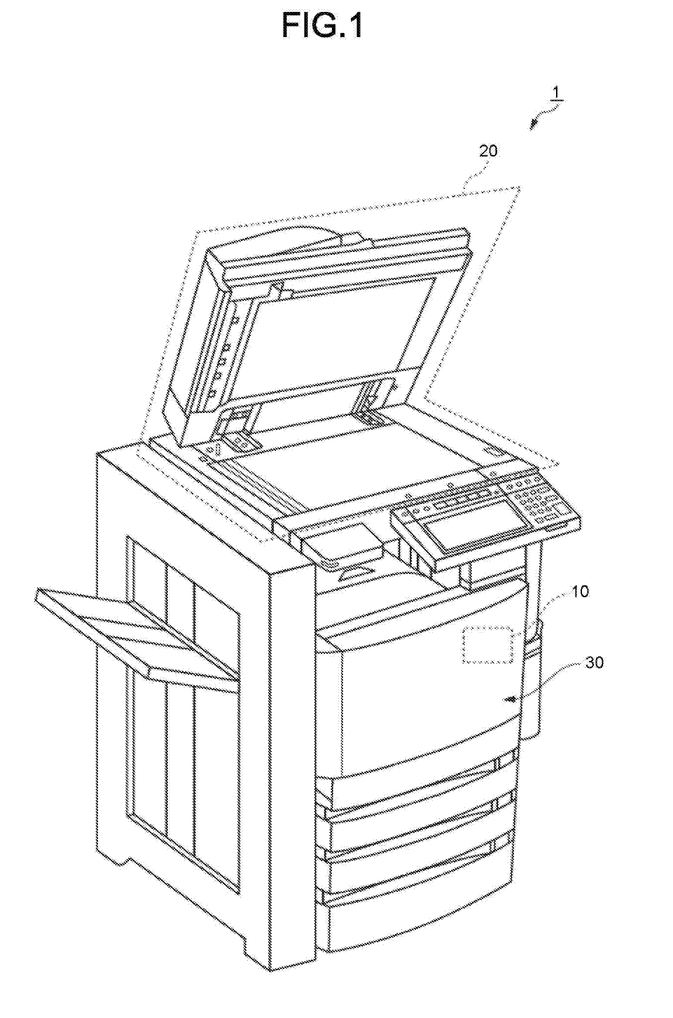

FIG. 1 is an external view exemplifying the overall constitution of an image forming apparatus 1 according to the present embodiment. The image forming apparatus 1 is, for example, a multi-functional peripheral. The image forming apparatus 1 includes a control device 10, an image reading section 20 and a printer section 30.

In the image forming apparatus 1, the control device 10 controls each functional section to form an image on a sheet using a toner. The sheet is, for example, a paper or a label paper. The sheet maybe an optional object as long as the image forming apparatus 1 can form an image on a surface thereof.

The image reading section 20 reads an image which is a reading object as intensity of light to generate image information. The image reading section 20 records the generated image information. The recorded image information may be transmitted to another informing processing apparatus via a network. The recorded image information may be used to form an image on the sheet by the printer section 130.

The printer section 30 includes an image forming section 30-1 (not shown) and a fixing section 30-2 (not shown). The image forming section 30-1 forms an image on the sheet based on image information generated by the image reading section 20 or image information received through a communication path. The image forming section 30-1 forms an electrostatic latent image on a photoconductive drum based on the image information. The image forming section 30-1 forms a visible image by attaching the toner to the electrostatic latent image. The image forming section 30-1 transfers the visible image onto the sheet. The fixing section 30-2 heats and pressurizes the sheet onto which the visible image is transferred. In this way, the visible image is fixed on the sheet. The sheet on which the image is formed may be a sheet housed in a sheet housing section of the image forming apparatus 1, or a sheet that is manually fed.

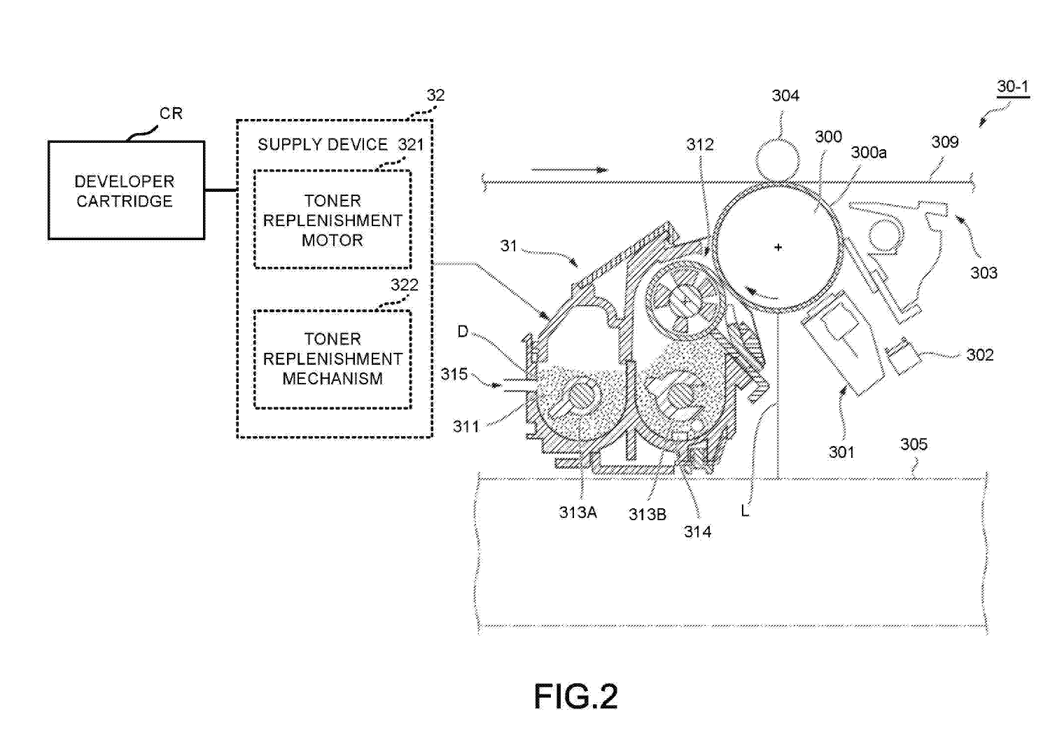

FIG. 2 is a schematic view of the cross section of the image forming section 30-1 centered on a developing section 31 of the image forming apparatus 1 according to the present embodiment. In the periphery of the developing section 31, a photoconductive drum 300 (image carrier), a charging section 301, a discharging section 302, a cleaning unit 303, and a transfer roller 304 are provided. The peripheral constitution of the developing section 31 described above is arranged corresponding to the number of colors of the toner of the image forming apparatus 1 (image forming section 30-1). In an example of the present embodiment, the colors of the toner provided in the image forming apparatus 1 are yellow (Y), magenta (M), cyan (C) and black (K). In the following description, “Y” is added to the end of the reference numeral in the constitution relating to the image formation by yellow (Y) toner. “M” is added to the end of the reference numeral in the constitution relating to the image formation by magenta (M) toner. “C” is added to the end of the reference numeral in the constitution relating to the image formation by cyan (C) toner. “C” is added to the end of the reference numeral in the constitution relating to the image formation by black (K) toner. “Y”, “M”, “C”, or “K” is omitted if the constitution relating to each toner is not distinguished. The exposure section 305 may be provided in the periphery of each developing section 31, respectively, or all the developing sections 31 may use the common exposure section 305. In this case, a laser light L is irradiated in the direction of the photoconductive drum 300 of the developing section 31 according to the operation of each developing section 31.

Each developing section 31 includes a developer housing section 311, a developing roller 312, mixers 313 (in this example, a first mixer 313A and a second mixer 313B), an auto sensor 314, and an opening 315.

The developing section 31 supplies the developer (developer D shown in FIG. 2) housed in the developer housing section 311 to the photoconductive drum 300.

The developer housing section 311 is a container for housing the developer. The developer is a mixture of a carrier composed of magnetic fine particles and each toner.

The first mixer 313A, the second mixer 313B and the developing roller 312 are arranged inside the developer housing section 311. The first mixer 313A and the second mixer 313B agitate the developer. If the developer is stirred by the mixer 313, the toner is frictionally charged. As a result, the toner adheres to the surface of the carrier by an electrostatic force.

The second mixer 313B is arranged below the developing roller 312. The second mixer 313B supplies the developer housed in the developer housing section 311 to the surface of the developing roller 312. The developing roller 312 rotates in a counterclockwise direction shown in FIG. 2 by the drive of a motor. The developing roller 312 is constituted by a magnetic body (magnet) in which a negative electrode and a positive electrode are arranged alternately along a circumferential shape. The developer supplied by the second mixer 313B is erected on the surface of the developing roller 312 according to a magnetic field distribution generated by the arrangement constitution of the magnetic body (magnet). The magnetic field distribution of the developing roller 312 can be switched.

The auto sensor 314 detects the density (hereinafter, toner density) of the toner in the developer in the developer housing section 311. Based on a detection result of the auto sensor 314, the control device 10 performs control to supply the developer from a developer cartridge CR housing the toner and the carrier to the developing section 31 (developer housing section 311). For example, if the detection result of the auto sensor 314 indicates that the toner density is equal to or less than a predetermined density, the control device 10 performs control to supply the developer to the developing section 31. If the amount of the developer in the developer housing section 311 is excessive, a part of the developer housed in the developer housing section 311 is discharged from the opening 315. Specifically, if the developer is housed in the developer housing section 311 in an amount equal to or larger than a predetermined amount, the developer is discharged from the opening 315. The predetermined amount refers to an amount of the developer that the developer housing section 311 can house or an amount of the developer suitable for printing.

The photoconductive drum 300 has a photoconductor layer 300a on the surface thereof. The photoconductive drum 300 is rotated in a clockwise direction in FIG. 2 by the drive of a motor (not shown).

The charging section 301 uniformly charges the surface of the photoconductive drum 300 (photoconductor layer 300a). For example, the charging section 301 charges the surface of the photoconductive drum 300 to a negative polarity. Only the toner adheres to the surface of the photoconductive drum 300 in the developer erected on the surface of the developing roller 312 as the charging section 301 charges the photoconductive drum 300. At this time, on the surface of the photoconductive drum 300, an electrostatic latent image is formed by the exposure section 305. Accordingly, the toner adheres to the electrostatic latent image of the photoconductive drum 300 from the developing roller 312. As a result, the toner image is formed on the surface of the photoconductive drum 300.

For example, the developing section 31Y develops the electrostatic latent image on the surface of the photoconductive drum 300Y with the yellow (Y) toner. The developing section 31M develops the electrostatic latent image on the surface of the photoconductive drum 300M with the magenta (M) toner. The developing section 31C develops the electrostatic latent image on the surface of the photoconductive drum 300C with the cyan (C) toner. The developing section 31K develops the electrostatic latent image on the surface of the photoconductive drum 300K with the black (K) toner.

The cleaning unit 303 removes the toner that is not transferred on the surface of the photoconductive drum 300 by scraping off the toner. The cleaning unit 303 is provided at rear stage of a position where the toner image on the surface of the photoconductive drum 300 is transferred onto the intermediate transfer belt 309. In the example in FIG. 2, the photoconductive drum 300 rotates clockwise in FIG. 2. Accordingly, the cleaning unit 303 is provided at the right side along a circumferential direction of the photoconductive drum 300 with reference to a transfer position on the intermediate transfer belt 309. Thereby, the cleaning unit 303 removes the toner on the surface of the photoconductive drum 300 after the toner image is transferred onto the intermediate transfer belt 309. The toner removed by the cleaning unit 303 is collected in a waste toner tank (not shown) to be discarded.

The discharging section 302 faces the photoconductive drum 300 going through the cleaning unit 303. The discharging section 302 irradiates the surface of the photoconductive drum 300 with light. Thus, the non-uniform charge on the photoconductor layer 300a becomes uniform. In other words, the photoconductor layer 300a is discharged.

The transfer roller 304 faces the photoconductive drum 300 across the intermediate transfer belt 309. The transfer roller 304 abuts against the surface of the photoconductive drum 300 across the intermediate transfer belt 309. The transfer roller 304 transfers (primary transfers) the toner image on the surface of the photoconductive drum 300 onto the intermediate transfer belt 309.

The exposure section 305 is arranged at a position facing the photoconductive drum 300 of each developing section 31. The exposure section 305 irradiates the surface of the photoconductive drum 300 of each developing section 31 with the laser light L. The exposure section 305 is controlled to emit the light based on the image data under the control of the control device 10. The exposure section 305 emits the laser light L based on the image data. As a result, on the surface of the photoconductive drum 300, a static pattern (electrostatic latent image) is formed at the position irradiated with the laser light L. In the exposure section 305, instead of the laser light, LED (Light Emitting Diode) light may be used.

The supply device 32 includes a toner replenishment motor 321 and a toner replenishment mechanism 322. The supply device 32 drives the toner replenishment motor 321 under the control of the control device 10. The toner replenishment motor 321 operates the toner replenishment mechanism 322. The toner replenishment mechanism 322 is connected to the developer cartridge CR. The toner replenishment mechanism 322 operates according to the driving of the toner replenishment motor 321 to supply the developer housed in the developer cartridge CR to the developer housing section 311. The supply device 32 supplies the developer to the developer housing section 311 under the control of the control device 10. The supply device 32 supplies the toner to the developing section 31 under the control of the control device 10, for example, if the detection result of the auto sensor 314 indicates that the toner density is equal to or less than the predetermined density.

The transfer section (not shown) transfers (secondarily transfers) the toner image primarily transferred onto the intermediate transfer belt 309 onto the surface of the sheet by the above-described constitution.

The fixing section 30-2 (not shown) of the printer section 30 applies the heat and pressure to the sheet. The fixing section 30-2 fixes the toner image transferred onto the sheet by the heat and pressure.

Here, the career of the developer is easy to be erected on the developing roller 312 if fully charged. Therefore, it is preferable that the career of the developer is fully charged. If the developer of an appropriate bulk is not housed in the developer housing section 311, a distance between the developing roller 312 and the developer becomes long. In this case, the developing roller 312 is difficult to make the developer sufficiently erected on the surface thereof. Therefore it is preferable that the developer housing section 311 houses the developer of the appropriate bulk at which the developer can be easily erected on the developing roller 312.

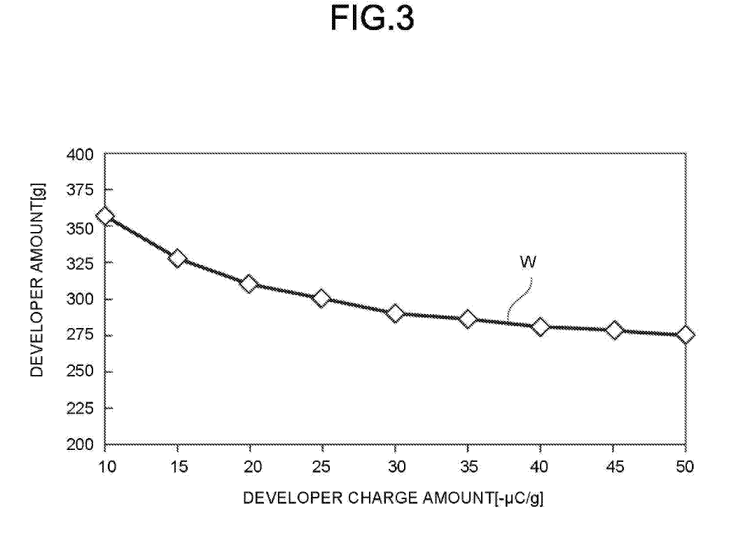

A waveform W shown in FIG. 3 shows the relationship between the amount of the developer required for the developer housing section 311 and the charge amount of the developer (carrier). As the charge amount of the toner becomes lower, the more developer is necessarily supplied to the developer housing section 311.

The amount of the developer in the volume of the developer housing section 311 is influenced by the charge amount of the developer. Even if the developer has the same mass, if the charge amount is small, the bulk of the developer becomes less in the developer housing section 311.

The charge amount of the developer is affected by the humidity of the surrounding environment where the image forming apparatus 1 is installed. Specifically, if the humidity of the surrounding environment of the image forming apparatus 1 is high, the developer is hard to charge.

Here, after the image forming apparatus 1 executes an image forming processing, there is a case in which the image forming processing is not executed for a long time and the surrounding environment of the image forming apparatus 1 may be a high humidity environment. In this case, the bulk of the developer in the developer housing section 311 of the image forming apparatus 1 decreases. If the bulk of the developer decreases, it is preferable that the image forming apparatus 1 discharges the (old) developer with the low charge amount in the developer housing section 311 and supplies new developer. In other words, the image forming apparatus 1 preferably keeps the bulk of the developer housed in the developer housing section 311 properly.

The image forming apparatus 1 of the present embodiment adjusts a toner discharge amount based on the humidity of the surrounding environment where the image forming apparatus 1 is installed and a standing time of the image forming apparatus 1. Thus, the image forming apparatus 1 of the present embodiment adjusts the bulk of the developer housed in the developer housing section 311.

Hereinafter, a specific constitution of the control device 10 of the image forming apparatus 1 is described with reference to the drawings.

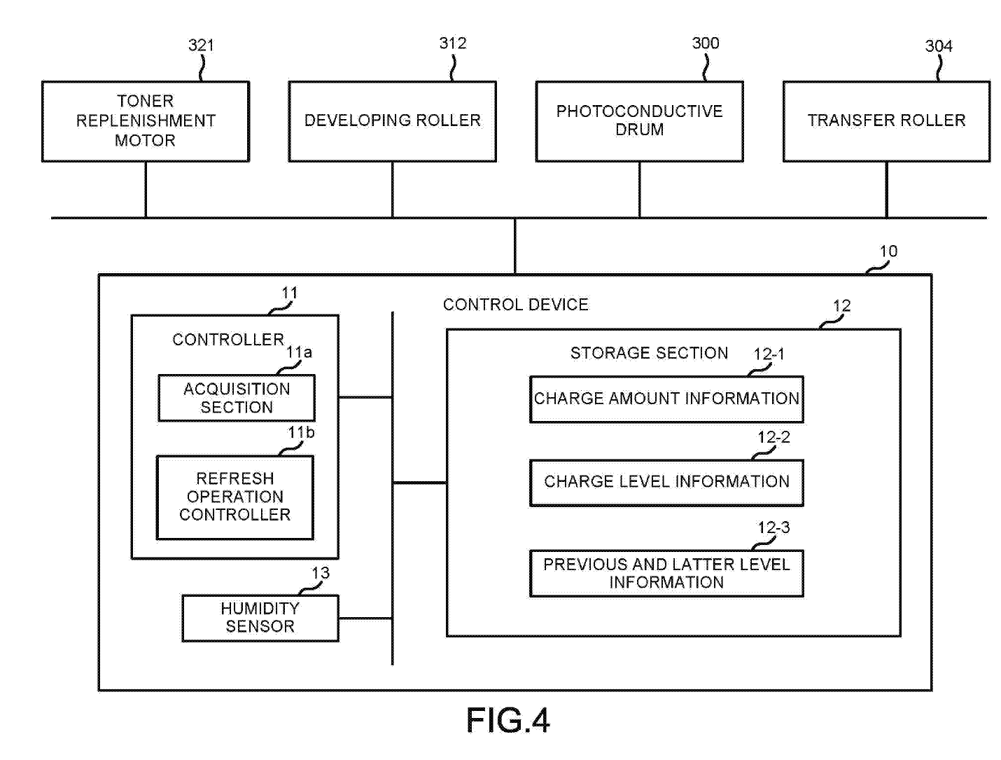

FIG. 4 is a functional constitution diagram illustrating an example of the constitution of the control device 10 included in the image forming apparatus 1 according to the present embodiment. The control device 10 includes a controller 11, a storage section 12, and a humidity sensor 13. The control device 10 is connected to be capable of communicating information with each section of the image forming apparatus 1. The components of the control device 10 are connected with one another by an internal bus line. The humidity sensor 13 detects the humidity of the surrounding environment of the image forming apparatus 1. The humidity sensor 13 supplies information (hereinafter, referred to as humidity information) indicating the detected surrounding humidity to the controller 11. The humidity sensor 13 detects the humidity at a predetermined time interval and supplies the humidity information to the controller 11.

In the storage section 12, charge amount information 12-1, charge level information 12-2, and previous and latter level information 12-3 are stored in advance.

The controller 11 includes a CPU (central processing unit) to execute a program stored in the storage section 12 to realize each functional section. The controller 11 realizes, for example, an acquisition section 11a and a refresh operation controller 11b as the functional sections thereof.

The acquisition section 11a acquires the humidity information from the humidity sensor 13. The acquisition section 11a acquires a charge level of the developer housed in the developer housing section 311 based on the acquired humidity information, standing time of the developer and the charge level information 12-2. The standing time of the developer refers to a time from the end of the image forming processing to the start of the next image forming processing. The standing time is a period (time) before a time at which the acquisition section 11a executes the processing of acquiring the charge level. For example, the acquisition section 11a acquires the charge level at a timing at which the next image forming processing is started or a timing at which the image forming apparatus 1 recovers from a standby operation state after the image forming processing is completed.

The details of the charge amount information 12-1 are described below with reference to the drawings.

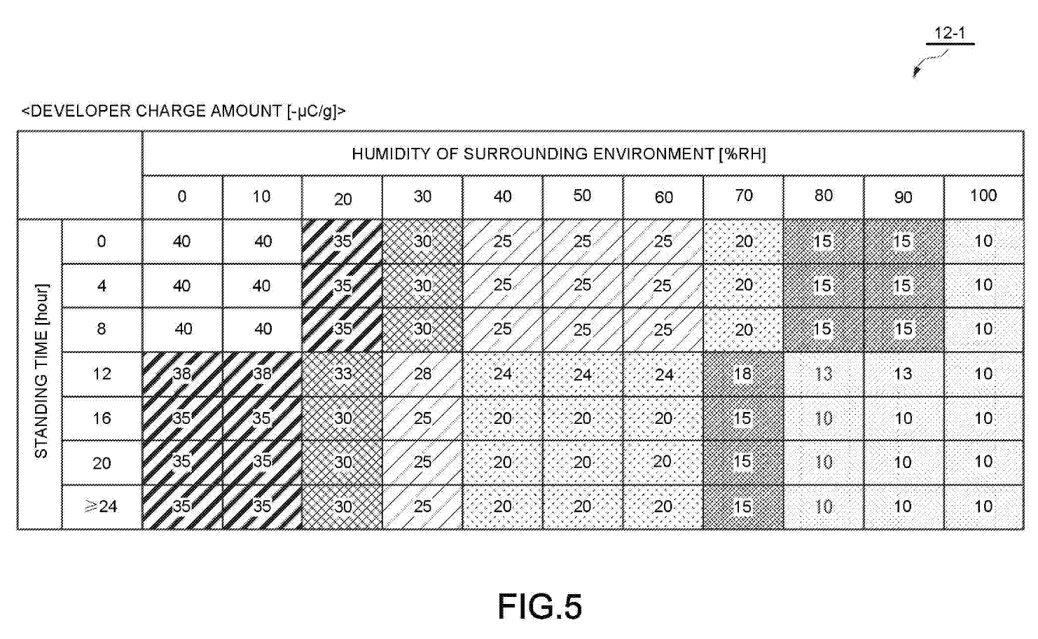

FIG. 5 is a table illustrating an example of the charge amount information 12-1 according to the present embodiment. The charge amount information 12-1 indicates the charge amount of the developer housed in the developer housing section 311 which is the charge amount corresponding to the humidity of the surrounding environment of the image forming apparatus 1 and the standing time. As shown in FIG. 5, the lower the humidity of the surrounding environment of the image forming apparatus 1 is or the shorter the standing time is, the more the charge amount of the developer becomes. The higher the humidity of the surrounding environment of the image forming apparatus 1 is or the longer the standing time is, the less the charge amount of the developer becomes. The charge amount of the developer indicated by the charge amount information 12-1 is determined by the material of the toner and the material of the carrier which are used as the developer.

The details of the charge level information 12-2 are described below with reference to the drawings.

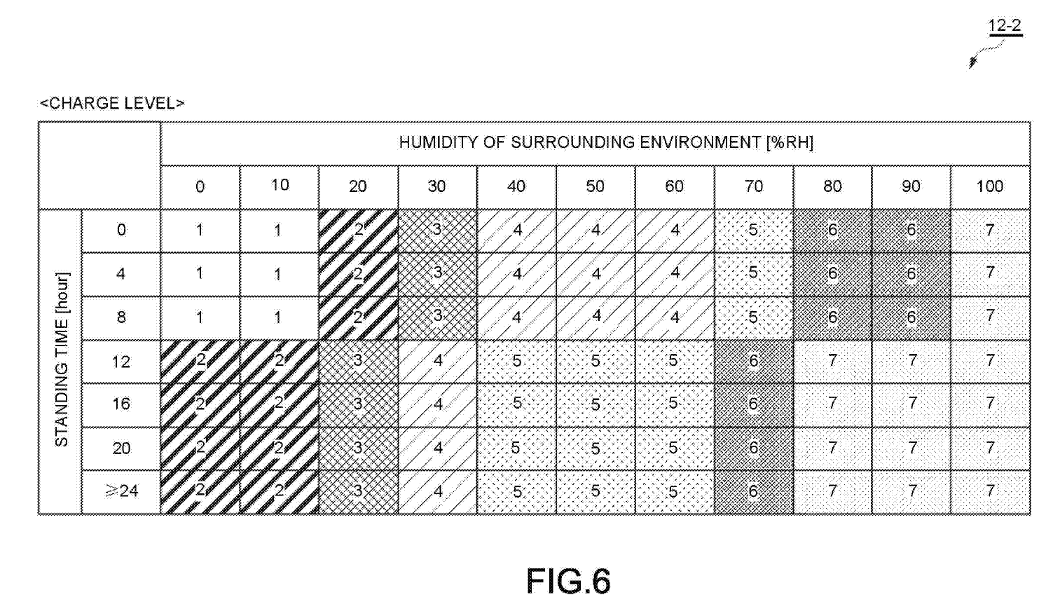

FIG. 6 is a table illustrating an example of the charge level information 12-2 according to the present embodiment. The charge level information 12-2 indicates a charge level of the developer corresponding to the humidity of the surrounding environment of the image forming apparatus 1 and the standing time. Specifically, the lower the humidity of the surrounding environment of the image forming apparatus 1 is or the shorter the standing time is, the smaller the value of the charge level of the developer becomes. The higher the humidity of the surrounding environment of the image forming apparatus 1 is or the longer the standing time is, the larger the value of the charge level of the developer becomes. The charge level of the developer indicated by the charge level information 12-2 corresponds to the charge amount indicated by the charge amount information 12-1.

Specifically, if the charge amount of the developer is 0˜14 [−μC/g], the developer is associated with a charge level 7. If the charge amount of the developer is 15˜18 [−μC/g], the developer is associated with a charge level 6. If the charge amount of the developer is 19˜24 [−μC/g], the developer is associated with a charge level 5. If the charge amount of the developer is 25˜28 [−μC/g], the developer is associated with a charge level 4. If the charge amount of the developer is 29˜34 [−μC/g], the developer is associated with a charge level 3. If the charge amount of the developer is 35˜38 [−μC/g], the developer is associated with a charge level 2. If the charge amount of the developer is equal to or greater than 39 [−μC/g], the developer is associated with a charge level 1.

Furthermore, the above-described charge level is an example, and the divided charge level may be a number larger than 7 or a number smaller than 7. The range of the charge amount of the developer at each charge level is merely an example, and the present invention is not limited thereto. The storage section 12 may store at least the charge level information 12-2 between the charge amount information 12-1 and the charge level information 12-2.

Returning to FIG. 4, and the refresh operation controller 11b controls a refresh operation. The refresh operation is a discharge operation for discharging at least a part of the toner in the developer housed in the developing section 31 (the developer housing section 311). Specifically, the refresh operation controller 11b controls the developing roller 312, the photoconductive drum 300, and the transfer roller 304 as the discharge operation. The refresh operation controller 11b drives the developing roller 312 to erect the developer in the developer housing section 311 on the surface of the developing roller 312. The refresh operation controller 11b attaches the toner to the photoconductive drum 300 in the developer erected on the developing roller 312. The refresh operation controller 11b enables the adhering toner not to adhere to the intermediate transfer belt 309 by the transfer roller 304 as the discharge operation which is the refresh operation. The toner attached to the photoconductive drum 300 is removed by the cleaning unit 303 as the discharge operation.

After the refresh operation, the refresh operation controller 11b enables the auto sensor 314 to detect the toner density of the developer in the developer housing section 311. In this case, based on the detection result of the auto sensor 314, the controller 11 performs control to supply the toner from the supply device 32 to the developing section 31 as the supply operation.

The refresh operation executes the discharge operation a predetermined number of times. In an example of the present embodiment, the amount of the toner discharged from the developer housing section 311 by one refresh operation is the same amount. The amount of the toner discharged from the developer housing section 311 by one refresh operation is, for example, an amount of the toner used for forming a solid toner pattern image having a size of several centimeters at a side five times. Since the toner density in the developer housing section 311 decreases with the discharge operation, the developer is supplemented from the developer cartridge CR based on the detection result of the auto sensor 314. Thus, charging ability of the toner in the developer housing section 311 is restored.

The refresh operation controller 11b acquires the number of times of execution of the refresh operation based on the charge level at a first time, the charge level at a second time, and the previous and latter level information 12-3. The charge level at the first time is a charge level of the developer in the developer housing section 311 which is acquired by the acquisition section 11a at a certain time. The second time is a time later than the first time. Therefore, the charge level at the second time is a charge level of the developer in the developer housing section 311 acquired by the acquisition section 11a at a time after the first time. The refresh operation controller 11b acquires the number of times of execution of the refresh operation based on the charge level at the first time, the charge level at the second time and the previous and latter level information 12-3.

The details of the previous and latter level information 12-3 are described below with reference to the drawings.

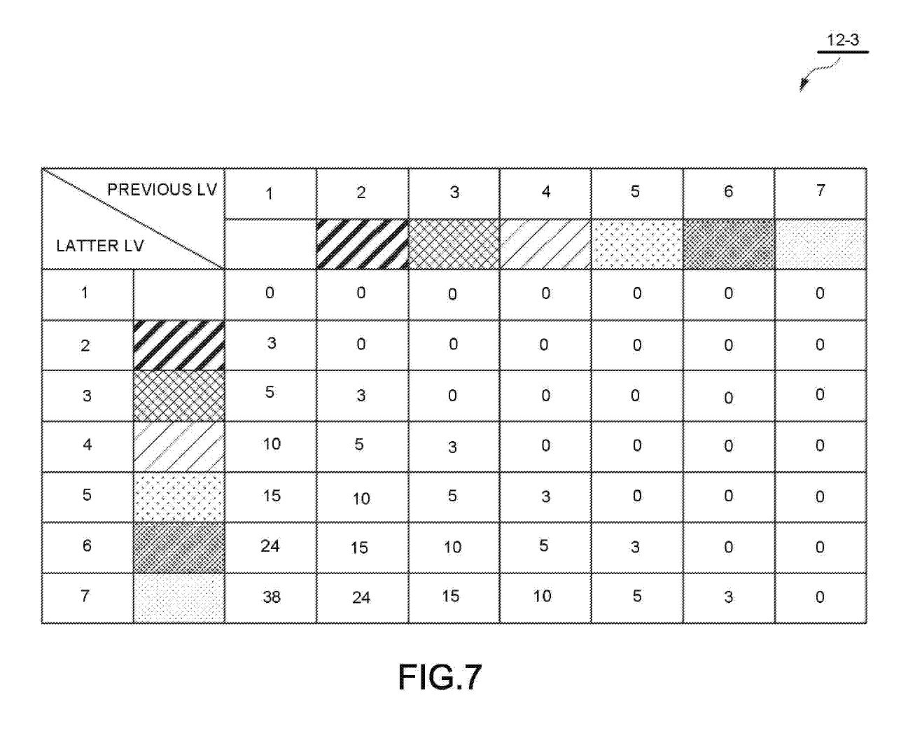

FIG. 7 is a table illustrating an example of the previous and latter level information 12-3 according to the present embodiment. The previous and latter level information 12-3 shows the correspondence between the charge level at the first time (hereinafter, referred to as a previous level), the charge level at the second time (hereinafter, referred to as a latter level), and the number of times. The second time is a time after the first time. The number of times shown in the previous and latter level information 12-3 is the number of times of the execution of the refresh operation.

In an example of the present embodiment, the previous and latter level information 12-3 includes seven kinds of times according to the correspondence between the previous level and the latter level. More specifically, the previous and latter level information 12-3 includes “0 time”, “3 times”, “5 times”, “10 times”, “15 times”, “24 times”, and “38 times”. In the previous and latter level information 12-3, a large number of times is associated if the latter level is lower than that of the previous level for the charge level of the developer.

More specifically, if a value obtained by subtracting the value of the previous level from the value of the latter level is “0” or less, “0 times” is associated. If the value obtained by subtracting the value of the previous level from the value of the latter level is “1”, “3 times” is associated. If the value obtained by subtracting the value of the previous level from the value of the latter level is “2”, “5 times” is associated. If the value obtained by subtracting the value of the previous level from the value of the latter level is “3”, “10 times” is associated. If the value obtained by subtracting the value of the previous level from the value of the latter level is “4”, “15 times” is associated. If the value obtained by subtracting the value of the previous level from the value of the latter level is “5”, “24 times” is associated. If the value obtained by subtracting the value of the previous level from the value of the latter level is “6”, “38 times” is associated.

Returning to FIG. 4, the refresh operation controller 11b controls each section of the image forming apparatus 1 to execute the refresh operation for the acquired number of times of the acquired refresh operation.

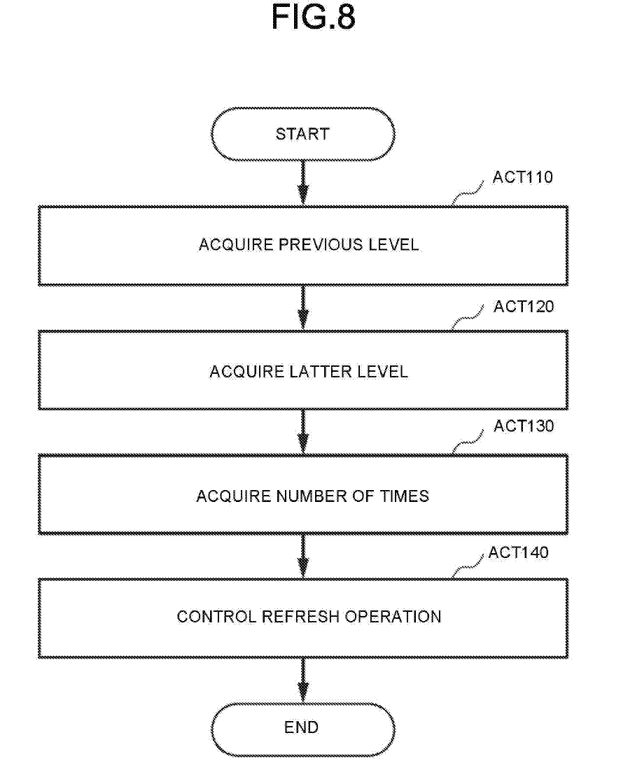

With reference to FIG. 8, the operation of the image forming apparatus 1 is described in detail.

FIG. 8 is a flowchart illustrating an example of the operation of the image forming apparatus 1 according to the present embodiment.

The acquisition section 11a acquires the charge level (previous level) at the first time based on the humidity information acquired by the humidity sensor 13 and the charge level information 12-2 (ACT 110). The acquisition section 11a acquires the charge level (latter level) at the second time based on the humidity information acquired by the humidity sensor 13 and the charge level information 12-2 (ACT 120). The refresh operation controller 11b acquires the number of times of the execution of the refresh operation based on the previous level and the latter level acquired by the acquisition section 11a (ACT 130). The refresh operation controller 11b controls each section of the image forming apparatus 1 to execute the refresh operation for the acquired number of times of the refresh operation (ACT 140).

As described above, the image forming apparatus 1 of the present embodiment includes the control device 10, the image reading section 20, and the printer section 30.

The humidity sensor 13 detects the humidity of the surrounding environment where the image forming apparatus 1 is installed. The control device 10 includes the acquisition section 11a and the refresh operation controller 11b as the functional sections thereof. The acquisition section 11a acquires the charge level of the developer in the developer housing section 311 based on the humidity information indicating the humidity detected by the humidity sensor 13 and the charge level information 12-2. The refresh operation controller 11b acquires the number of times of the execution of the refresh operation based on the previous level, the latter level, the standing time of the developer and the previous and latter level information 12-3. The refresh operation controller 11b controls each section of the image forming apparatus 1 to execute the refresh operation for the acquired number of times.

Accordingly, the image forming apparatus 1 of the present embodiment controls the refresh operation based on the humidity of the surrounding environment and the standing time of the developer housed in the developer housing section 311. Therefore, the image forming apparatus 1 of the present embodiment can keep the bulk of the developer appropriately based on the humidity of the surrounding environment and the standing time of the developer housed in the developer housing section 311.

Furthermore, in the image forming apparatus 1 of the present embodiment, the amount of the toner discharged from the developer housing section 311 in one refresh operation is the same amount. The refresh operation controller 11b acquires the number of times of execution of the refresh operation corresponding to the difference between the previous level and the latter level. Specifically, if the difference between the previous level and the latter level is large, the refresh operation controller 11b enables each section to perform the refresh operation more times than a case in which the difference is small. Here, a case in which the difference between the previous level and the latter level is large indicates that the environment around the image forming apparatus 1 is a high humidity environment or that the standing time of the developer in the developer housing section 311 is long. In other words, a case in which the difference between the previous level and the latter level is large indicates that the charge amount of the developer in the developer housing section 311 is low, i.e., the bulk of the developer is low. According to the image forming apparatus 1 of the present embodiment, based on the humidity of the surrounding environment and the standing time of the developer in the developer housing section 311, it is possible to keep the bulk of the developer properly by a simple method.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. An image forming apparatus, comprising:
a humidity sensor configured to detect surrounding humidity;
a developing device configured to house a developer containing a toner;
a toner density sensor configured to detect toner density in a developer in the developing device;
a supply device configured to supply the developing device with the developer based on a detection result of the toner density sensor;
an acquisition section configured to acquire a charge level of the developer in the developing device based on the detection result of the humidity sensor and a time from the completion of an image forming to the start of the next image forming; and
a controller configured to control a discharge operation of enabling the developing device to discharge the toner based on a first charge level acquired by the acquisition section at a first time and a second charge level acquired by the acquisition section at a second time after the first time.

2. The image forming apparatus according to claim 1, further comprising:
an image carrier; and
a cleaner section that removes toner remaining on the image carrier, wherein
the discharge operation is an operation of forming a toner image on the image carrier and removing the toner image by the cleaner section.

3. The image forming apparatus according to claim 1, wherein
the developing device has an opening for discharging at least a part of the housed developer, and
if an amount of the developer exceeds a predetermined amount in the developing device, the developer in the developing device is discharged from the opening.

4. The image forming apparatus according to claim 1, wherein
a discharge amount of the toner in one refresh operation is the same amount, and
the controller acquires a number of times of execution of the discharge operation based on the first charge level and the second charge level and controls the discharge operation for the acquired number of times.

5. The image forming apparatus according to claim 4, wherein
the controller acquires the number of times according to a difference between the first charge level and the second charge level.

6. The image forming apparatus according to claim 4, wherein
if the difference between the first charge level and the second charge level is large, the number of times of execution of the discharge operation is associated with a greater number of times compared with a case in which the difference is small.

7. The image forming apparatus according to claim 4, wherein
if there is no difference between the first charge level and the second charge level, 0 times is associated with the number of times of execution of the discharge operation.

8. The image forming apparatus according to claim 1, wherein
the developing device discharges a developer which is housed for a long time in the housed developer to an outside by the discharge operation.

9. The image forming apparatus according to claim 1, wherein
the supply device supplies the developer of an amount corresponding to the amount of the developer discharged to an outside by the discharge operation.

10. An image forming method by an image forming apparatus comprising a humidity sensor for detecting surrounding humidity, a developing device for housing a developer containing a toner, a toner density sensor for detecting toner density in the developer in the developing device, and a supply device for supplying the developing device with the developer based on a detection result of the toner density sensor, including:
acquiring a charge level of the developer in the developing device based on the detection result of the humidity sensor and a time from the completion of an image forming to the start of a next image forming; and
controlling a discharge operation of enabling the developing device to discharge the toner based on a first charge level acquired by the acquisition section at a first time and a second charge level acquired by the acquisition section at a second time after the first time.
